(19) United States
(12) Patent Application Publication
(10) Pub. No.: US 2014/0189211 A1
(43) Pub. Date: Jul. 3, 2014

(54) Remapping Blocks in a Storage Device

(71) Applicant: SanDisk Enterprise IP LLC, Milpitas, CA (US)

(72) Inventors: Johann George, Sunnyvale, CA (US); Aaron Olbrich, Morgan Hill, CA (US)

(21) Appl. No.: 13/831,374

(22) Filed: Mar. 14, 2013

Related U.S. Application Data
(60) Provisional application No. 61/747,750, filed on Dec. 31, 2012.

(51) Int. Cl. G06F 12/02

(52) U.S. Cl. CPC G06F 12/0246
USPC 711/103; 711/159

(57) ABSTRACT

In the present disclosure, a persistent storage device includes both persistent storage, which includes a set of persistent storage blocks, and a storage controller. The persistent storage device stores and retrieves data in response to commands received from an external host device. The persistent storage device stores a logical block address to physical address mapping. The persistent storage device also, in response to a remapping command, stores an updated logical block address to physical block address mapping.

### RELATED APPLICATIONS

This application claims priority to U.S. Provisional Patent Application No. 61/747,750, filed Dec. 31, 2012, which is hereby incorporated by reference in its entirety.

### TECHNICAL FIELD

The disclosed embodiments relate generally to storage devices.

### BACKGROUND

It is well known that logically contiguous storage provides for more efficient execution of input/output operations than logically noncontiguous storage. However, over time and as more operations are performed, storage typically becomes fragmented, thus leading to less efficient operations.

The embodiments described herein provide mechanisms and methods for more efficient reads and writes to storage devices.

### SUMMARY

In the present disclosure, a persistent storage device includes persistent storage, which includes a set of persistent storage blocks, and a storage controller. The persistent storage device stores and retrieves data in response to commands received from an external host device. The persistent storage device stores a logical block address to physical address mapping. The persistent storage device also, in response to a remapping command, stores an updated logical block address to physical block address mapping.

### BRIEF DESCRIPTION OF THE DRAWINGS

FIG. 1 is a block diagram illustrating a system that includes a persistent storage device and an external host device, in accordance with some embodiments.

FIG. 2A is a schematic diagram corresponding to an initial logical block address to physical address mapping, in accordance with some embodiments.

FIG. 2B is a schematic diagram corresponding to an updated logical block address to physical address mapping after processing a remapping command, in accordance with some embodiments.

FIG. 3 is flow diagram illustrating the processing of a host remapping command by a persistent storage device, in accordance with some embodiments.

FIGS. 4A-4B illustrate a flow diagram of a process for remapping blocks in a persistent storage device, including processing a host remapping command, in accordance with some embodiments.

Like reference numerals refer to corresponding parts throughout the drawings.

### DESCRIPTION OF EMBODIMENTS

In some embodiments, data stored by a host device in persistent storage becomes fragmented over time. When that happens, it is difficult to allocate contiguous storage. In some embodiments, applications on the host cause the host to perform input/output (I/O) operations using non-contiguous data stored in persistent storage. In such embodiments, performing I/O operations using non-contiguous data is less efficient than performing I/O operations using contiguous blocks of data. In some embodiments, the host defragments a storage device once it has become fragmented. For example, in some cases, the host suspends all applications and runs processes for defragmenting the storage device. In that case, an application cannot perform an operation until the defragmentation processes are complete. In another example, the host runs the defragmentation processes while an application is still running. Because the defragmentation processes are running simultaneously with the application, the application's performance slows down. In both cases, the time for an application to complete an operation increases, thereby decreasing efficiency.

In the present disclosure, a persistent storage device includes persistent storage, which includes a set of persistent storage blocks, and a storage controller. The storage controller is configured to store and retrieve data in response to commands received from an external host device. The storage controller is also configured to store, in the persistent storage device, a logical block address to physical address mapping. The storage controller is further configured to, in response to a remapping command, which specifies a set of replacement logical block addresses and a set of initial logical block addresses that are to be replaced by the replacement logical block addresses in the stored logical block address to physical address mapping, store an updated logical block address to physical block address mapping. The set of mappings of the initial logical block addresses map the initial logical block addresses to corresponding physical block addresses for persistent storage blocks in the persistent storage. The set of mappings of the initial logical block addresses are replaced by a set of mappings of the replacement logical block addresses specified by the remapping command. The set of mappings of the replacement logical block addresses map the replacement logical block addresses to the same physical block addresses that, prior to execution of the remapping command, corresponded to the initial logical block addresses.

In some embodiments, the storage controller is configured to store the updated logical block address to physical block address mapping, in response to the remapping command, without transferring data from the persistent storage blocks corresponding to the initial logical block addresses to other persistent storage blocks in the persistent storage.

In some embodiments, the replacement logical block addresses comprise a contiguous set of logical block addresses and the initial logical block addresses comprise a non-contiguous set of logical block addresses.

In some embodiments, the updated logical block address to physical block address mapping maps a contiguous set of logical block addresses that includes the replacement logical block addresses to a set of physical block addresses that include the physical block addresses to which the initial logical block addresses were mapped immediately prior to execution of the remapping command by the persistent storage device.

In some embodiments, the persistent storage device further includes a controller memory distinct from the persistent storage. In some embodiments, the updated logical block address to physical block address mapping is stored in the controller memory. In some embodiments, the controller memory is non-volatile. In some embodiments, the controller memory includes non-volatile memory selected from the group consisting of battery backed DRAM, battery backed SRAM, supercapacitor backed DRAM or SRAM, ferroelectric RAM, magnetoresistive RAM, phase-change RAM, and flash memory. In some embodiments, the persistent storage device is implemented as a single, monolithic integrated circuit. In some embodiments, the persistent storage device also includes a host interface for interfacing the persistent storage device to the external host device. In some embodiments, the remapping command is received from the external host device.

In another aspect of the present disclosure, a method for remapping blocks in a persistent storage device is provided. In some embodiments, the method is performed at the persistent storage device, which includes persistent storage and a storage controller. The persistent storage includes a set of persistent storage blocks. The method includes storing a logical block address to physical address mapping. The method further includes, in response to a remapping command, which specifies a set of replacement logical block addresses and a set of initial logical block addresses that are to be replaced by the replacement logical block addresses in the stored logical block address to physical address mapping, storing an updated logical block address to physical block address mapping. The set of mappings of the initial logical block addresses map the initial logical block addresses to corresponding physical block addresses for persistent storage blocks in the persistent storage. The set of mappings of the initial logical block addresses are replaced by a set of mappings of the replacement logical block addresses specified by the remapping command. The set of mappings of the replacement logical block addresses map the replacement logical block addresses to the same physical block addresses that, prior to execution of the remapping command, corresponded to the initial logical block addresses.

In yet another aspect of the present disclosure, a non-transitory computer readable storage medium stores one or more programs for execution by a storage controller of a persistent storage device. Execution of the one or more programs by the storage controller causes the storage controller to perform any of the methods described above.

Reference will now be made in detail to various embodiments, examples of which are illustrated in the accompanying drawings. In the following detailed description, numerous specific details are set forth in order to provide a thorough understanding of the invention and the described embodiments. However, the invention may be practiced without these specific details. In other instances, well-known methods, procedures, components, and circuits have not been described in detail so as not to unnecessarily obscure aspects of the embodiments.

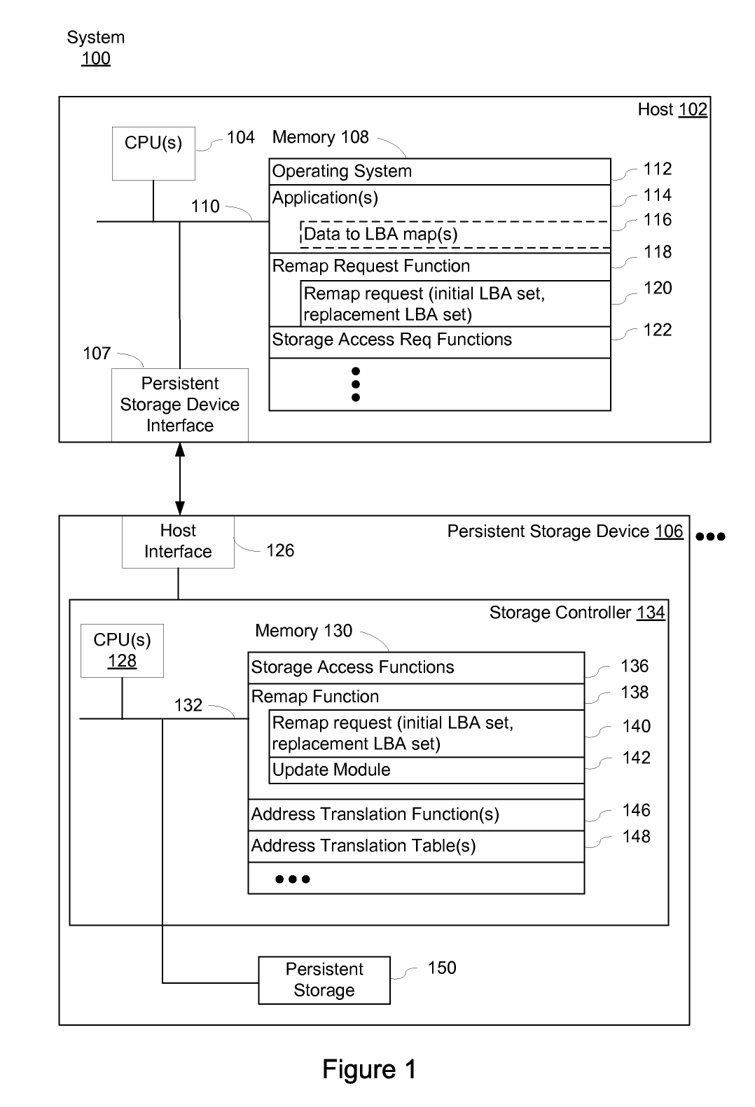

FIG. 1 is a block diagram illustrating a system 100 that includes a persistent storage device 106 and an external host device 102 (sometimes herein called host 102), in accordance with some embodiments. For convenience, host 102 is herein described as implemented as a single server or other single computer. Host 102 includes one or more processing units (CPU's) 104, one or more memory interfaces 107, memory 108, and one or more communication buses 110 for interconnecting these components. The communication buses 110 optionally include circuitry (sometimes called a chipset) that interconnects and controls communications between system components. Memory 108 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Further, memory 108 optionally includes one or more storage devices remotely located from the CPU(s) 104. Memory 108, or alternately the non-volatile memory device(s) within memory 108, includes a non-volatile computer readable storage medium. In some embodiments, memory 108 or the non-volatile computer readable storage medium of memory 108 stores the following programs, modules and data structures, or a subset thereof:

an operating system 112 that includes procedures for handling various basic system services and for performing hardware dependent tasks;

one or more applications 114 which are configured to (or include instructions to) submit read and write commands to persistent storage device 106 using storage access request functions 122; one or more applications 114 optionally utilize data to LBA map(s) 116, for example, to keep track of which logical block addresses contain particular data;

remap request function 118, for issuing a remapping command to persistent storage device 106; in some implementations a remapping command includes remap request 120, which includes an initial LBA set and a replacement LBA set; and

storage access request functions 122 for issuing storage access commands to persistent storage device 106 (e.g., read, write and erase commands, for reading data from persistent storage 150, writing data to persistent storage, and erasing data in persistent storage 150).

Each of the aforementioned host functions, such as storage access functions 122, is configured for execution by the one or more processors (CPUs) 104 of host 102, so as to perform the associated storage access task or function with respect to persistent storage 150 in persistent storage device 106.

In some embodiments, host 102 is connected to persistent storage device 106 via a memory interface 107 of host 102 and a host interface 126 of persistent storage device 106. Host 102 is connected to persistent storage device 106 either directly or through a communication network (not shown) such as the Internet, other wide area networks, local area networks, metropolitan area networks, wireless networks, or any combination of such networks. Optionally, in some implementations, host 102 is connected to a plurality of persistent storage devices 106, only one of which is shown in FIG. 1.

In some embodiments, persistent storage device 106 includes persistent storage 150, one or more host interfaces 126, and storage controller 134. Storage controller 134 includes one or more processing units (CPU's) 128, memory 130, and one or more communication buses 132 for interconnecting these components. Storage controller 134 is sometimes called a solid state driver (SSD) controller. In some embodiments, communication buses 132 include circuitry (sometimes called a chipset) that interconnects and controls communications between system components. Memory 130 (sometimes herein called controller memory 130) includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 130 optionally includes one or more storage devices remotely located from the CPU(s) 128. Memory 130, or alternately the non-volatile memory device(s) within memory 130, includes a non-volatile computer readable storage medium. In some embodiments, memory 130 stores the following programs, modules and data structures, or a subset thereof:

storage access functions 136 for handling storage access commands issued by host 102 as a result of calling storage access request functions 122;

remap function 138 for handling remapping commands issued by host 102; in some implementations remap function 138 processes a respective remap request 140, which includes an initial LBA set and a replacement LBA set, and corresponds to remap request 120 in a remapping command received from host 102; in some embodiments, remap function 138 includes update module 142 for replacing an initial LBA set and a replacement LBA set, both of which are specified by a remapping command received by persistent storage device 106;

one or more address translation functions 146 for translating logical block addresses to physical addresses; and

one or more address translation tables 148 for storing logical to physical address mapping information.

Each of the aforementioned storage controller functions, such as storage access functions 136 and remap function 138, is configured for execution by the one or more processors (CPUs) 128 of storage controller 134, so as to perform the associated task or function with respect to persistent storage 150.

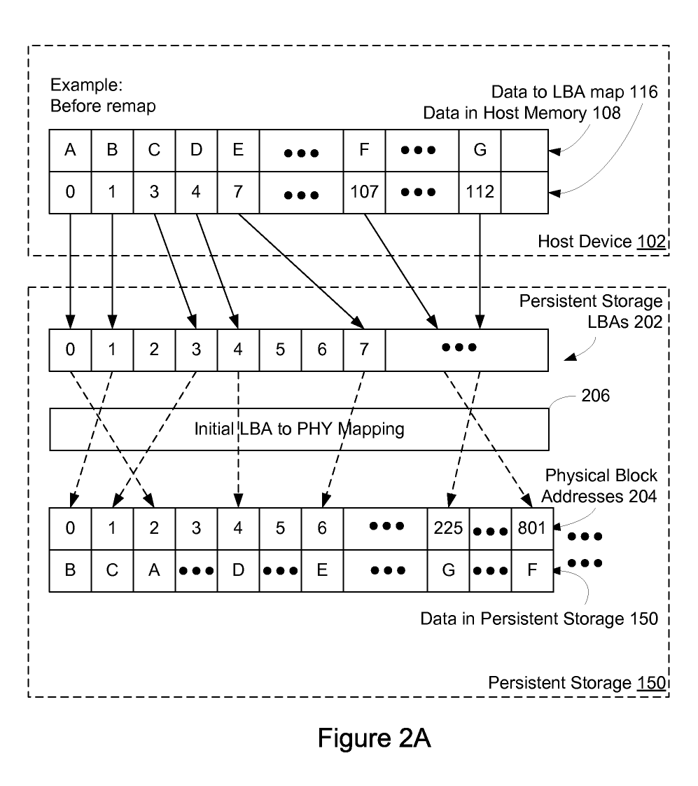

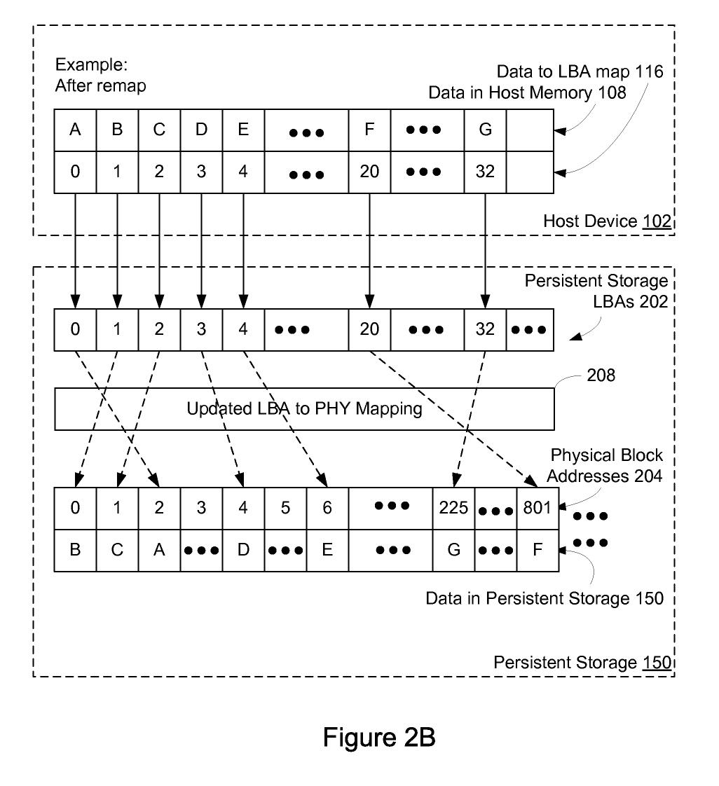

Address translation function(s) 146 together with address translation tables 148 implement a logical block address (LBA) to physical address (PHY) mapping, shown as initial LBA to PHY mapping 206 in FIG. 2A and replacement LBA to PHY mapping 208 in FIG. 2B.

As used herein, “updating” the LBA to PHY mapping refers to replacing initial LBA to PHY mapping 206 with updated LBA to PHY mapping 208. In some implementations, the updated LBA to PHY mapping is implemented as a new address translation table 148. In some implementations, “updating” the LBA to PHY mapping refers to updating certain fields in existing address translation tables 148. In some embodiments, initial LBA to PHY mapping 206 is erased after storage controller 134 stores updated LBA to PHY mapping 208 to address translation tables 148 using update module 142. Alternatively, initial LBA to PHY mapping 206 is not erased after storing updated LBA to PHY mapping. In some embodiments, storage controller 134 “updates” the LBA to PHY mapping by replacing initial LBAs in address translation tables 148 with replacement LBAs. As used herein, “replacing” an initial LBA with a replacement LBA refers to associating a physical address, initially associated with an initial LBA, with a replacement LBA.

In some embodiments, with respect to specific examples of commands given below, as used herein, “moving” data “from” an initial logical block address “to” a replacement logical block address refers to replacing the initial logical block address, associated with the physical block address that stores the data, with the replacement logical block address, without moving data from one physical address to another. Instead, the physical block addresses of the “moved” data are associated with replacement logical block addresses in an address translation table, or logical block address to physical address mapping, or equivalent mechanism for mapping between logical and physical addresses.

As used herein, the term “persistent storage” refers to any type of persistent storage used as mass storage or secondary storage. In some embodiments, persistent storage is flash memory. In some implementations, persistent storage 150 includes a set of persistent storage blocks. Persistent storage blocks have corresponding physical addresses in persistent storage 150.

In some embodiments, commands issued by host 102, using the storage access request functions 122 described above, are implemented as input/output control (ioctl) function calls, for example Unix or Linux ioctl function calls or similar function calls implemented in other operating systems. In some embodiments, commands are issued to persistent storage device 106 as a result of function calls by host 102.

An example of a remapping command, e.g., resulting from an application 144 calling remap request function 118, issued by host 102 to update the LBA to PHY mapping in persistent storage device 106, is given by:

remap(dst1, src1, len1, dst2, src2, len2, . . . )

where len# refers to an integer number of logical block addresses to be remapped for a given (dst#, src#, len#) triplet in the remapping command, (src# len#) refers to a set of len# initial logical block addresses starting at src# (i.e., a contiguous set of logical block addresses ranging from src# to src#+len#−1) in the current LBA to PHY mapping (e.g., initial LBA to PHY mapping 206, FIG. 2A) of persistent storage device 106, and (dst#, len#) refers to a set of len# replacement logical block addresses starting at dst# (i.e., a contiguous set of logical block addresses ranging from dst# to dst#+len#−1) that are to replace the set of initial block addresses in the LBA to PHY mapping of persistent storage device 106. The number of (dst#, src#, len#) triplets in the remap command has no specific limit, and can generally range from one triplet to several dozen triplets or, optionally, hundreds of triplets, depending on the implementation. In some embodiments, src# in combination with len# represents an initial LBA set, and dst# in combination with len# represents a replacement LBA set.

Each of the above identified modules, applications or programs corresponds to a set of instructions, executable by the one or more processors of host 102 or persistent storage device 106, for performing a function described above. The above identified modules, applications or programs (i.e., sets of instructions) need not be implemented as separate software programs, procedures or modules, and thus various subsets of these modules may be combined or otherwise re-arranged in various embodiments. In some embodiments, memory 108 or memory 130 optionally stores a subset of the modules and data structures identified above. Furthermore, in some implementations, memory 108 or memory 130 optionally stores additional modules and data structures not described above.

Although FIG. 1 shows a system 100 including host 102 and persistent storage device 106, FIG. 1 is intended more as a functional description of the various features which may be present in a set of servers than as a structural schematic of the embodiments described herein. In practice, and as recognized by those of ordinary skill in the art, items shown separately could be combined and some items could be separated.

FIGS. 2A and 2B illustrate a schematic diagram of host device 102 and persistent storage 150, in accordance with some embodiments. As illustrated in FIGS. 2A and 2B, a data to LBA map 116 is stored in memory 108 of host 102. In some embodiments, with respect to FIG. 2A, persistent storage 150 maps persistent storage LBAs 202 to physical block addresses 204 via an initial LBA to PHY mapping 206. In some embodiments, with respect to FIG. 2B, persistent storage 150 maps persistent storage LBAs 202 to physical block addresses 204 via updated LBA to PHY mapping 208. As mentioned above, in some embodiments, storage controller 134 replaces initial LBA to PHY mapping 206 with updated LBA to PHY mapping 208 using update module 142. In some embodiments, initial LBA to PHY mapping 206 and updated LBA to PHY mapping 208 are implemented through address translation functions 146 and address translation tables 148, as described above.

As described above with reference to FIG. 1, host 102 issues a remapping command (sometimes herein called a host remapping command). In some embodiments, the remapping command results from an instance of a call by a host application to the remap function, as described above. For example, and without limitation, an application can perform a “virtual garbage collection” operation that consolidates and reorders the set of logical block addresses (LBAs) used by the application, without actually sending any commands to persistent storage device 106, which produces a remapping of the LBAs used by the application. Continuing with the example, that remapping is then expressed as a remapping command that is sent to the persistent storage device 106, which causes the persistent storage device 106 to replace or update its LBA to PHY mapping, typically implemented by an address translation table and address translation function. All of this is done without changing the physical storage locations of any of the data used by the application, except for those situations where the new logical locations cannot be mapped to the original physical storage locations due to limitations in LBA to PHY mapping mechanism of persistent storage 150. In the latter situations, data is moved to new physical storage locations to which the new logical locations can be mapped. However, it is anticipated that in most implementations and most circumstances, the replacement or updating of the LBA to PHY mapping will be accomplished without changing the physical storage locations of any of the data used by the application. In some embodiments, the remapping command is issued by any of the one or more CPU(s) 104 of host 102 through memory interface 107 and received by storage controller 134 via host interface 126.

FIG. 2A is a schematic diagram corresponding to an initial logical block address to physical address mapping, e.g., LBA to PHY mapping 206, in accordance with some embodiments. Data to LBA map 116, stored in memory 108 of host 102, indicates which data is mapped to particular persistent storage LBAs by host 102 (e.g., by one or more applications or memory mapping functions executed by host 102). As exemplified in FIG. 2A, the set of persistent storage LBAs 202 used by host 102 is fragmented (non-contiguous). For example, LBAs 0, 1, 3, 4, and 7 correspond to persistent storage blocks that contain data, while LBAs 2, 5, and 6 do not (i.e., LBAs 2, 5 and 6 are unused). For ease of reference, FIG. 2A also shows specific items of data (e.g., “A,” “B,” “C,” etc.) stored in host memory 108 at the top of FIG. 2A, and corresponding items of data (e.g., “A,” “B,” “C,” etc.) stored in persistent storage 150. By “following the arrows” (i.e., the data to LBA map 116, and then the LBA to PHY mapping 206), the physical storage block in persistent storage 150 can be identified for each datum in host memory 108.

FIG. 2B is a schematic diagram corresponding to an updated logical block address to physical address mapping, e.g., updated LBA to PHY mapping 208, after processing an example remapping command, e.g., remap (2, 3, 2, 4, 7, 1, . . . ), in accordance with some embodiments. In this example, the first triple (2, 3, 2) of the remapping command specifies that two logical block addresses, starting at logical block address 3 be remapped to logical block addresses starting at logical block address 2. The second triple (4, 7, 1) of the remapping command specifies that one logical block address, starting at logical block address 7, be moved to logical block address 4. As illustrated in FIG. 2B, after the example remapping command has been processed, the logical block addresses have been defragmented. Furthermore, in this example, the replacement logical block addresses (specified by the remapping command) form a contiguous set of logical block addresses, while the initial logical block addresses (specified by the remapping command) do not.

As noted above, in some embodiments, execution of the remapping command by the persistent storage device does not require physically moving data to new storage locations. In the example illustrated in FIGS. 2A and 2B, data is initially stored in physical addresses 0, 1, 2, 4, 6, 801 and 225, as shown in FIG. 2A. After processing the remapping command, the same data is still stored in physical addresses 0, 1, 2, 4, 6, 801 and 225 as shown in FIG. 2B. Thus, the actual data has not been moved to a different physical location in persistent storage 150, but rather the logical to physical mapping has been updated and stored as updated LBA to PHY mapping 208.

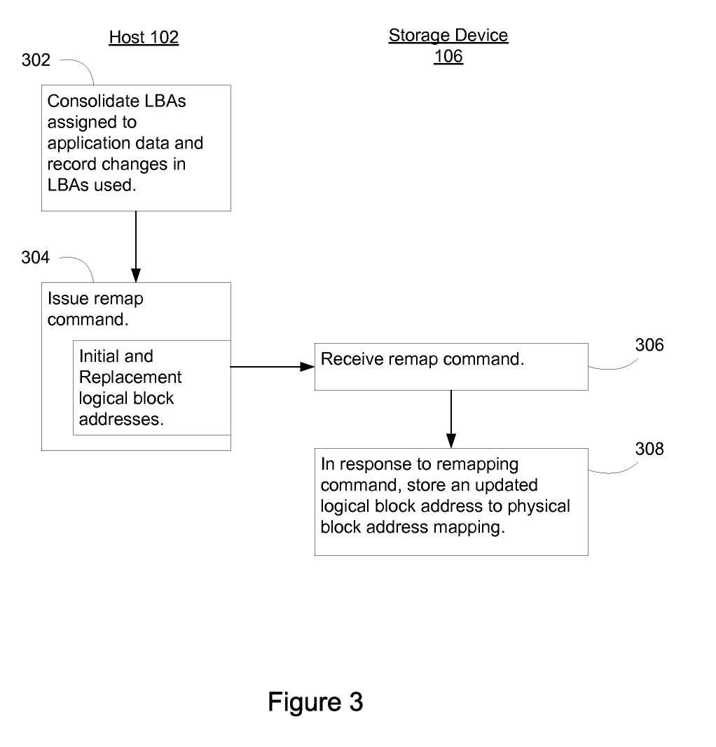

FIG. 3 is a flow diagram illustrating the processing of a host remapping command received from host 102 by persistent storage device 106, in accordance with some embodiments. As mentioned above, in some implementations, the host remapping command is received from host 102 by persistent storage device 106 via host interface 126. In some embodiments, one or more applications 114 execute storage access request functions 122 for storing, in memory 108, application data in persistent storage device 106. As mentioned above, host 102 optionally stores, e.g., in data to LBA map 116, a mapping between application data and the persistent storage logical block addresses used to store the application data.

In some embodiments, prior to issuing a remapping command, host 102 first consolidates (302) or otherwise modifies the LBAs assigned to application data and records changes in the LBAs used. In some embodiments, the consolidated LBAs, including any changes to the LBAs used, are stored in data to LBA map(s) 116. Host 102 then issues (304) a remapping command. In some embodiments, the remapping command includes initial and replacement sets of logical block addresses. In some embodiments, the initial and replacements sets of logical block addresses correspond to changes made by host 102 to one or more data to LBA map(s) 116 while consolidating or otherwise modifying the LBAs assigned to application data. Persistent storage device 106 receives (306) the remapping command. In response, storage controller 134 of persistent storage device 106 stores (308) an updated logical block address to physical block address mapping. For example, the updated mapping is stored in controller memory 130 of the storage controller 134. In some embodiments, operation 308 occurs when storage controller 134 calls remap function 138 and, utilizing update module 142, stores a revised logical to physical mapping, e.g., updated LBA to PHY mapping 208 (using the replacement set of logical block addresses in the received remapping command) to one or more address translation table(s) 148 in controller memory 130.

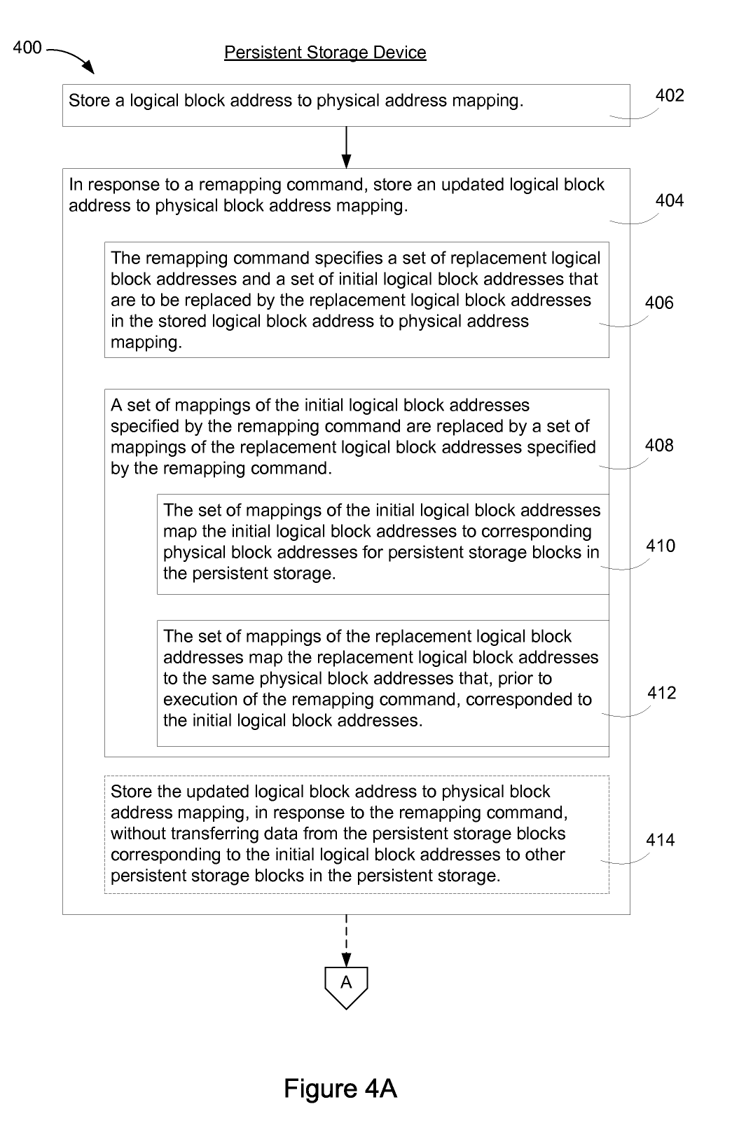

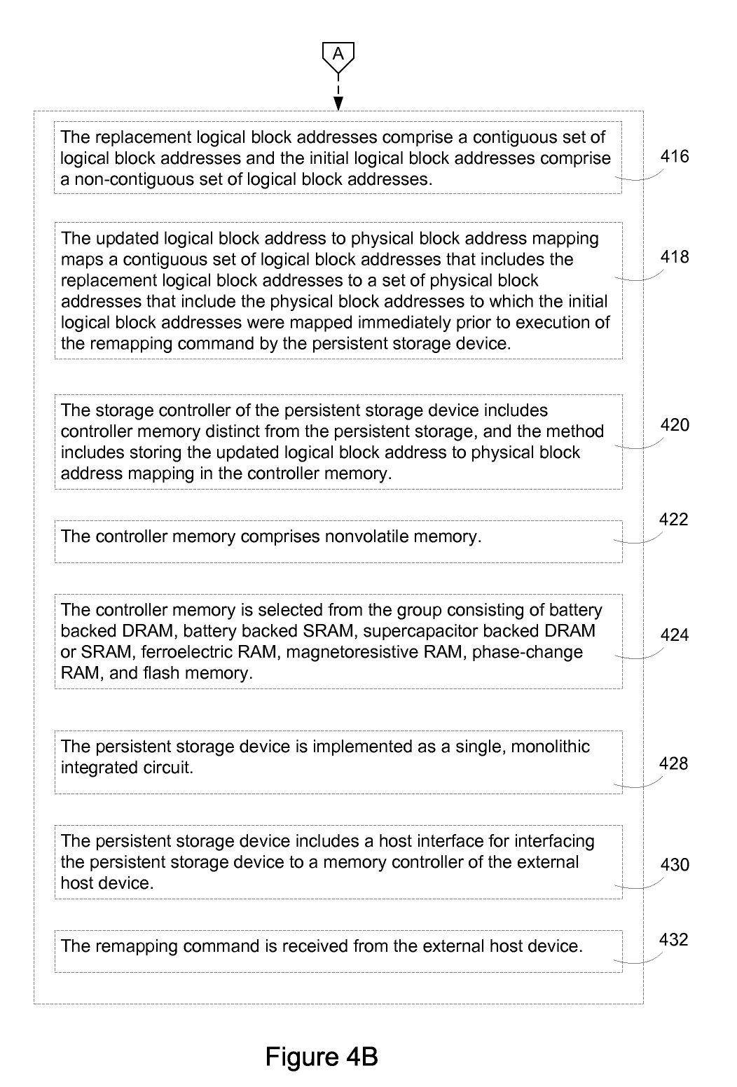

FIGS. 4A-4B illustrate a flowchart representing a method 400 for remapping blocks in a persistent storage device, such as persistent storage device 106 shown in FIG. 1, according to some embodiments. Method 400 includes operations for processing a host remapping command. In some embodiments, method 400 is governed by instructions that are stored in a computer readable storage medium and that are executed by one or more processors of a device, such as the one or more processors 128 of storage controller 134 of persistent storage device 106, shown in FIG. 1.

In some embodiments, persistent storage device 106 stores (402) a logical block address to physical address mapping, e.g., initial LBA to PHY mapping 206 illustrated in FIG. 2A.

In response to a remapping command, persistent storage device 106 stores (404) an updated logical block address to physical block address mapping, e.g., updated LBA to PHY mapping 208 illustrated in FIG. 2B. Operation 404 corresponds to operation 308 in FIG. 3, as described above. As discussed above, the remapping command is typically received (432) from the external host device. The remapping command specifies (406) a set of replacement logical block addresses and a set of initial logical block addresses that are to be replaced by the replacement logical block addresses in the stored logical block address to physical address mapping.

A set of mappings of the initial logical block addresses specified by the remapping command are replaced (408) by a set of mappings of the replacement logical block addresses specified by the remapping command. The set of mappings of the initial logical block addresses, e.g., initial LBA to PHY mapping 206, map (410) the initial logical block addresses to corresponding physical block addresses, e.g., physical block addresses 204, for persistent storage blocks in the persistent storage. The set of mappings of the replacement logical block addresses, e.g., updated LBA to PHY mapping 208, map (412) the replacement logical block addresses to the same physical block addresses that, prior to execution of the remapping command, corresponded to the initial logical block addresses.

As noted above, in some embodiments, persistent storage device 106 stores (414) the updated logical block address to physical block address mapping, in response to the remapping command, without transferring or moving data from the persistent storage blocks corresponding to the initial logical block addresses to other persistent storage blocks in the persistent storage. As a result, the physical block addresses of the data corresponding to the initial logical block addresses specified by the remapping command remain unchanged. Optionally, in some circumstances and/or other implementations, in which data is stored in persistent storage blocks that cannot be mapped to the specified replacement logical address blocks (e.g., due to limitations imposed by the logic or architecture of the persistent storage device), the data in those data blocks is moved to new persistent storage blocks that are compatible with the specified replacement logical block addresses.

In some embodiments, the replacement logical block addresses comprise (416) a contiguous set of logical block addresses and the initial logical block addresses comprise a non-contiguous set of logical block addresses. While this aspect depends on the specific replacement logical block addresses and initial logical block addresses specified by the remapping command, the remapping command is thus useful for performing “garbage collection” with respect to the logical block addresses used by a host computer or device, or an application executed by the host, so as to consolidate (and optionally reorder, as needed) the set of logical block addresses used into a contiguous set of logical block addresses.

In some embodiments, the updated logical block address to physical block address mapping maps (418) a contiguous set of logical block addresses, which includes the replacement logical block addresses, to a set of physical block addresses that include the physical block addresses to which the initial logical block addresses were mapped immediately prior to execution of the remapping command by the persistent storage device.

In some embodiments, the storage controller of the persistent storage device includes controller memory distinct from the persistent storage, and method 400 includes (420) storing the updated logical block address to physical block address mapping in the controller memory. In some embodiments, the controller memory comprises (422) nonvolatile memory. Optionally, the controller memory is selected (424) from the group consisting of battery backed DRAM, battery backed SRAM, supercapacitor backed DRAM or SRAM, ferroelectric RAM, magnetoresistive RAM, phase-change RAM, and flash memory. Supercapacitors are also sometimes called electric double-layer capacitors (EDLCs), electrochemical double layer capacitors, or ultracapacitors.

In some embodiments, persistent storage device 106 is implemented (428) as a single, monolithic integrated circuit. In some embodiments, the persistent storage device includes (430) host interface 126 for interfacing persistent storage device 106 to external host device 102.

Each of the operations shown in FIGS. 4A-4B optionally corresponds to instructions stored in a computer memory or computer readable storage medium, such as memory 130 of storage controller 134. The computer readable storage medium optionally includes a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

Although the terms “first,” “second,” etc. are used herein to describe various elements, these elements should not be limited by these terms. These terms are only used to distinguish one element from another. For example, a first contact could be termed a second contact, and, similarly, a second contact could be termed a first contact, without changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the disclosed embodiments to the precise forms disclosed. Many modifications and variations are possible in view of the above teachings. The embodiments were chosen and described in order to best explain the principles of the present disclosure and its practical applications, to thereby enable others skilled in the art to best utilize the disclosed embodiments and various other embodiments with various modifications as are suited to the particular use contemplated.

What is claimed is:

1. A persistent storage device, comprising:
persistent storage, comprising a set of persistent storage blocks; and
a storage controller configured to store and retrieve data in response to commands received from an external host device, the storage controller further configured to:
store, in the persistent storage device, a logical block address to physical address mapping; and
in response to a remapping command, which specifies a set of replacement logical block addresses and a set of initial logical block addresses that are to be replaced by the replacement logical block addresses in the stored logical block address to physical address mapping, store an updated logical block address to physical block address mapping in which a set of mappings of the initial logical block addresses specified by the remapping command, which map the initial logical block addresses to corresponding physical block addresses for persistent storage blocks in the persistent storage, are replaced by a set of mappings of the replacement logical block addresses specified by the remapping command, which map the replacement logical block addresses to the same physical block addresses that, prior to execution of the remapping command, corresponded to the initial logical block addresses.

2. The persistent storage device of claim 1, wherein the storage controller is configured to store the updated logical block address to physical block address mapping, in response to the remapping command, without transferring data from the persistent storage blocks corresponding to the initial logical block addresses to other persistent storage blocks in the persistent storage.

3. The persistent storage device of claim 1, wherein the replacement logical block addresses comprise a contiguous set of logical block addresses and the initial logical block addresses comprise a non-contiguous set of logical block addresses.

4. The persistent storage device of claim 1, wherein, the updated logical block address to physical block address mapping maps a contiguous set of logical block addresses that includes the replacement logical block addresses to a set of physical block addresses that include the physical block addresses to which the initial logical block addresses were mapped immediately prior to execution of the remapping command by the persistent storage device.

5. The persistent storage device of claim 1, the storage controller further including a controller memory distinct from the persistent storage, wherein the updated logical block address to physical block address mapping is stored in the controller memory.

6. The persistent storage device of claim 5, wherein the controller memory is non-volatile.

7. The persistent storage device of claim 5, wherein the controller memory comprises nonvolatile memory selected from the group consisting of battery backed DRAM, battery backed SRAM, supercapacitor backed DRAM or SRAM, ferroelectric RAM, magnetoresistive RAM, phase-change RAM, and flash memory.

8. The persistent storage device of claim 1, wherein the persistent storage device is implemented as a single, monolithic integrated circuit.

9. The persistent storage device of claim 1, further comprising a host interface for interfacing the persistent storage device to the external host device.

10. The persistent storage device of claim 1, wherein the remapping command is received from the external host device.

11. A method for remapping blocks in a persistent storage device, comprising:
at the persistent storage device comprising persistent storage and a storage controller, the persistent storage comprising a set of persistent storage blocks:
storing a logical block address to physical address mapping; and
in response to a remapping command, which specifies a set of replacement logical block addresses and a set of initial logical block addresses that are to be replaced by the replacement logical block addresses in the stored logical block address to physical address mapping, store an updated logical block address to physical block address mapping in which a set of mappings of the initial logical block addresses specified by the remapping command, which map the initial logical block addresses to corresponding physical block addresses for persistent storage blocks in the persistent storage, are replaced by a set of mappings of the replacement logical block addresses specified by the remapping command, which map the replacement logical block addresses to the same physical block addresses that, prior to execution of the remapping command, corresponded to the initial logical block addresses.

12. The method of claim 11, including storing the updated logical block address to physical block address mapping, in response to the remapping command, without transferring data from the persistent storage blocks corresponding to the initial logical block addresses to other persistent storage blocks in the persistent storage.

13. The method of claim 11, wherein the replacement logical block addresses comprise a contiguous set of logical block addresses and the initial logical block addresses comprise a non-contiguous set of logical block addresses.

14. The method of claim 11, wherein, the updated logical block address to physical block address mapping maps a contiguous set of logical block addresses that includes the replacement logical block addresses to a set of physical block addresses that include the physical block addresses to which the initial logical block addresses were mapped immediately prior to execution of the remapping command by the persistent storage device.

15. The method of claim 11, wherein the storage controller of the persistent storage device includes controller memory distinct from the persistent storage, and the method includes storing the updated logical block address to physical block address mapping in the controller memory.

16. The method of claim 15, wherein the controller memory comprises nonvolatile memory.

17. The method of claim 11, wherein the controller memory is selected from the group consisting of battery backed DRAM, battery backed SRAM, supercapacitor backed DRAM or SRAM, ferroelectric RAM, magnetoresistive RAM, phase-change RAM, and flash memory.

18. The method of claim 11, wherein the persistent storage device is implemented as a single, monolithic integrated circuit.

19. The method of claim 11, wherein the persistent storage device further comprises a host interface for interfacing the persistent storage device to an external host device.

20. The method of claim 11, wherein the remapping command is received from an external host device.

21. A non-transitory computer readable storage medium storing one or more programs for execution by a storage controller of a persistent storage device, the persistent storage device comprising persistent storage and the storage controller, the persistent storage comprising a set of persistent storage blocks, wherein the one or more programs, when executed by the storage controller of the persistent storage device, cause the persistent storage device to perform a method comprising:
storing, in a controller memory, a logical block address to physical address mapping; and
in response to a remapping command, which specifies a set of replacement logical block addresses and a set of initial logical block addresses that are to be replaced by the replacement logical block addresses in the stored logical block address to physical address mapping, store an updated logical block address to physical block address mapping in which a set of mappings of the initial logical block addresses specified by the remapping command, which map the initial logical block addresses to corresponding physical block addresses for persistent storage blocks in the persistent storage, are replaced by a set of mappings of the replacement logical block addresses specified by the remapping command, which map the replacement logical block addresses to the same physical block addresses that, prior to execution of the remapping command, corresponded to the initial logical block addresses.

22. The non-transitory computer readable storage medium of claim 21, wherein the remapping command is received from an external host device.
